(19) United States
(12) Patent Application Publication
(10) Pub. No.: US 2024/0343038 A1
(43) Pub. Date: Oct. 17, 2024

(54) LIQUID DISCHARGE HEAD AND LIQUID DISCHARGE APPARATUS

(71) Applicant: Tetsu MORINO, Kanagawa (JP)

(72) Inventor: Tetsu MORINO, Kanagawa (JP)

(21) Appl. No.: 18/629,130

(22) Filed: Apr. 8, 2024

(30) Foreign Application Priority Data
Apr. 11, 2023 (JP) 2023-064301

(51) Int. Cl. B41J 2/14; B41J 2/175

(52) U.S. Cl. CPC B41J 2/14; B41J 2/175; B41J 2002/14491

(57) ABSTRACT

A liquid discharge head includes a supply connector, a signal connector, and a cover. The supply connector is connectable to a supply path to be supplied with a liquid from the supply path. The signal connector is connectable to a signal wire through which an electrical signal is transmitted. The cover is movable between an exposing position where the signal connector is exposed to be connectable with the signal wire and a covering position where the cover covers the signal connector from which the signal wire is disconnected.

### CROSS-REFERENCE TO RELATED APPLICATION

This patent application is based on and claims priority pursuant to 35 U.S.C. § 119 (a) to Japanese Patent Application No. 2023-064301, filed on Apr. 11, 2023, in the Japan Patent Office, the entire disclosure of which is hereby incorporated by reference herein.

### BACKGROUND

### Technical Field

Embodiments of the present disclosure relate to a liquid discharge head and a liquid discharge apparatus.

### Related Art

In the related art, a liquid discharge apparatus employs a technique of detachably connecting a supply tube for supplying liquid to a liquid discharge head detachably mounted on a carriage. In addition, a liquid discharge apparatus employs a technique of detachably connecting a wiring cable for supplying, for example, an electrical signal and power to a liquid discharge head.

### SUMMARY

Embodiments of the present disclosure describe an improved liquid discharge head that includes a supply connector, a signal connector, and a cover. The supply connector is connectable to a supply path to be supplied with a liquid from the supply path. The signal connector is connectable to a signal wire through which an electrical signal is transmitted. The cover is movable between an exposing position where the signal connector is exposed to be connectable with the signal wire and a covering position where the cover covers the signal connector from which the signal wire is disconnected.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of a liquid discharge apparatus according to an embodiment of the present disclosure, with a housing closed;

FIG. 2 is a plan view of the liquid discharge apparatus of FIG. 1;

FIG. 3 is a perspective view of the liquid discharge apparatus of FIG. 1 with a part of the housing open;

FIG. 4 is a plan view of the liquid discharge apparatus of FIG. 3;

FIG. 5 is a plan view of a liquid discharge unit according to an embodiment of the present disclosure;

FIG. 6 is a perspective view of a carriage on which a liquid discharge head is mounted according to an embodiment of the present disclosure;

FIG. 7 is a perspective view of the liquid discharge head of FIG. 6 with the illustration of a side wall of the carriage omitted;

FIG. 8 is a perspective view of the liquid discharge head of FIG. 7 from which a cover and other parts are removed;

FIG. 9 is a perspective view of the liquid discharge head of FIG. 7 with one socket connected to a signal wire;

FIG. 10 is a perspective view of the liquid discharge head of FIG. 7 from which the signal wire is being removed;

FIG. 11 is a perspective view of the liquid discharge head of FIG. 7 with a cover preventing liquid from staining a socket;

FIG. 12 is a perspective view of the liquid discharge head of FIG. 11 without the cover, allowing liquid to stain the socket;

FIG. 13 is a perspective view of a liquid discharge head including another cover according to an embodiment of the present disclosure;

FIG. 14 is a perspective view of the liquid discharge head of FIG. 13 as viewed in a different direction; and

FIG. 15 is a perspective view of the liquid discharge head of FIG. 7 with a cover from which liquid falls onto a socket.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge head and a liquid discharge apparatus according to embodiments of the present disclosure are described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

The liquid discharge head according to the present embodiment is mounted on a carriage. The liquid discharge head includes: a supply path connector (may be referred to simply as a supply connector) that can be connected to a supply path for supplying liquid to the liquid discharge head; a signal wire connector (may be referred to simply as a signal connector) that can be connected to a signal wire for transmitting an electrical signal to the liquid discharge head; and a cover that covers the signal connector. The cover is disposed at a position where the cover does not cover the signal connector when the signal connector and the signal wire are connected. The cover moves to a position where the cover covers the signal connector when the signal wire is removed from the signal connector.

The liquid discharge apparatus according to the present embodiment includes the carriage on which the liquid discharge head according to the present embodiment is mounted, the supply path, and the signal wire.

Embodiments of the present disclosure are described below with reference to the drawings. In the drawings, like reference signs denote like elements, and overlapping description may be simplified or omitted as appropriate.

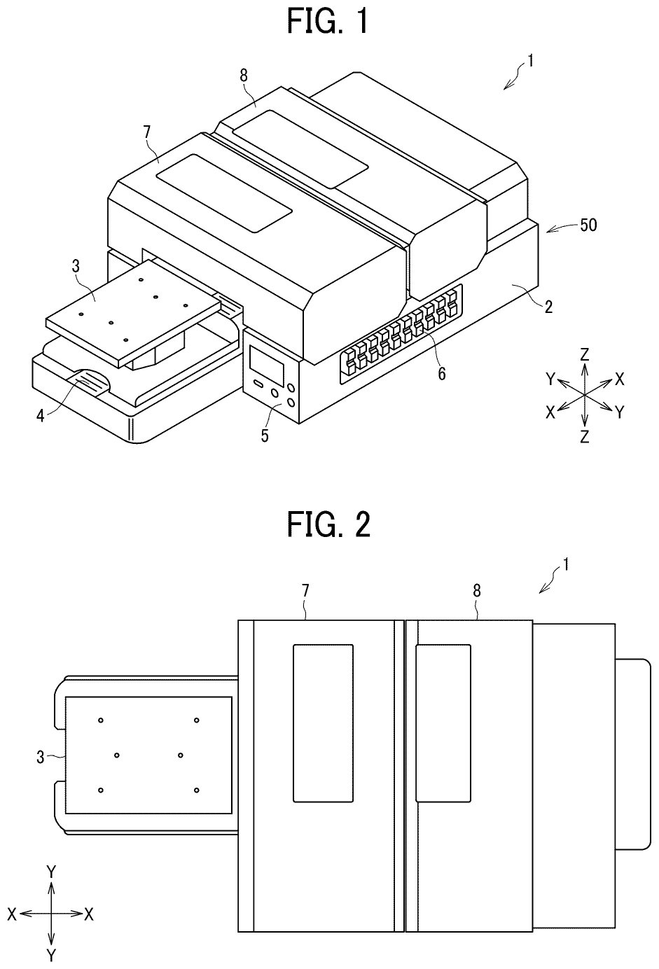

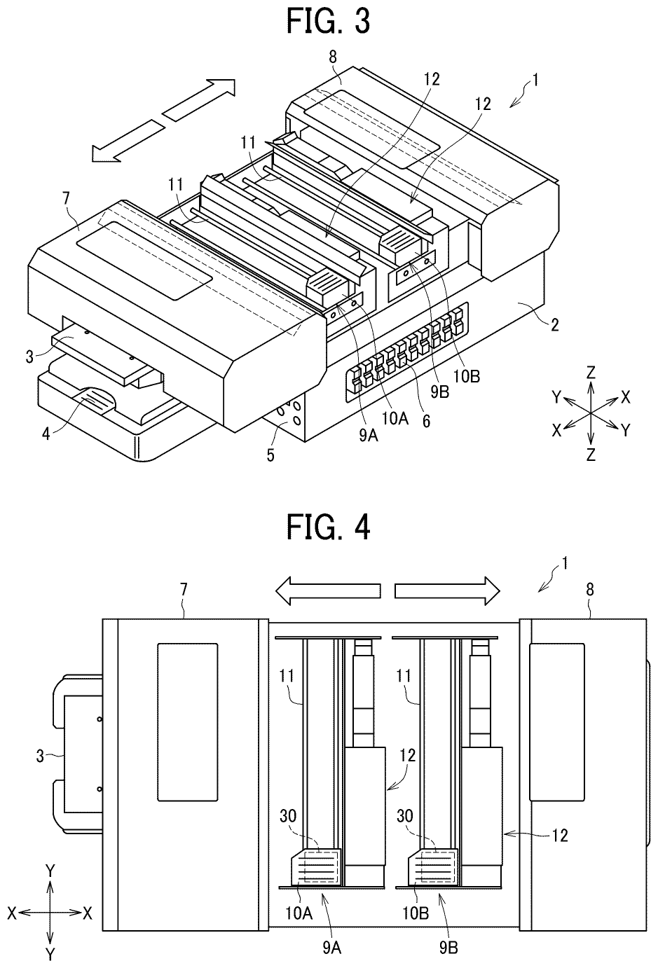

FIG. 1 is a perspective view of a liquid discharge apparatus 1 according to an embodiment of the present disclosure, with a housing closed, and FIG. 2 is a plan view thereof. FIG. 3 is a perspective view of the liquid discharge apparatus 1 of FIG. 1, according to the present embodiment, with covers open, and FIG. 4 is a plan view thereof. Directions X in FIG. 1 are the front-rear direction, sub-scanning direction, and recording-medium conveyance direction of the liquid discharge apparatus 1. Directions Y in FIG. 1 are the transverse direction and main scanning direction of the liquid discharge apparatus 1. Directions Z in FIG. 1 are the vertical directions of the liquid discharge apparatus 1. The X directions and the Y directions are parallel to a surface, onto which a liquid is discharged, of a recording medium on a stage 3, but may have some error. The X, Y, and Z directions are orthogonal to each other.

As illustrated in FIGS. 1 and 2, the liquid discharge apparatus 1 includes the stage 3 in front of a housing 2. The stage 3 is mounted on a guide rail 4. The guide rail 4 extends in the X directions. A control panel 5 is disposed on the front face of the housing 2. An ink cartridge 6 is detachably attached to a side face of the housing 2. A front cover 7 and a rear cover 8 as a part of a housing are disposed over the housing 2.

The stage 3 has a flat upper face on which the recording medium is placed. The upper face of the stage 3 is parallel to the directions X and the directions Y. The stage 3 moves on the guide rail 4 to reciprocate in both the directions X. The stage 3 is movable up and down in the directions Z. Thus, the height of the recording medium placed on the stage 3 is adjustable.

The front cover 7 and the rear cover 8 are movable in both the directions X. In FIG. 1, the front cover 7 has been moved backward and the rear cover 8 has been moved forward to close the front cover 7 and the rear cover 8 (i.e., a closed position). On the other hand, in FIG. 3, the front cover 7 is moved forward and the rear cover 8 is moved backward to open the front cover 7 and the rear cover 8 (i.e., an open position).

As described above, the front cover 7 and the rear cover 8 are slidably opened and closed. As a result, an occupied space of the liquid discharge apparatus 1 including an opening and closing space of each of the front cover 7 and the rear cover 8 can be reduced as compared with a configuration in which a front cover and a rear cover are opened and closed in the vertical direction. The front cover 7 and the rear cover 8 have openings at both ends in the front-rear direction. When the front cover 7 and the rear cover 8 are closed, the front cover 7 and the rear cover 8 are continuously arranged in the front-rear direction.

As illustrated in FIGS. 3 and 4, an apparatus body 50 of the liquid discharge apparatus 1 includes, for example, the housing 2 and liquid discharge units 9A and 9B mounted on the housing 2. In the present embodiment, specifically, the apparatus body 50 is a portion of the liquid discharge apparatus 1 other than the front cover 7 and the rear cover 8. The front cover 7 and the rear cover 8 are slidable in the directions X relative to the apparatus body 50.

The front cover 7 and the rear cover 8 are opened to expose the liquid discharge units 9A and 9B to the outside of the liquid discharge apparatus 1. When the liquid discharge units 9A and 9B are exposed to the outside, an operator can clean a maintenance unit 30, the liquid discharge head, and the surroundings thereof, or can replace carriages. The front cover 7 and the rear cover 8 are closed during image formation. As a result, the liquid discharge units 9A and 9B are covered by the front cover 7 and the rear cover 8 to block access to operation units such as the carriages of the liquid discharge units 9A and 9B from the outside.

The liquid discharge units 9A and 9B are disposed in the closed space in the front cover 7 or the rear cover 8. Accordingly, a mist of ink (liquid) is prevented from scattering to environs outside the liquid discharge apparatus 1 while the liquid discharge head discharges the ink to the recording medium (i.e., during liquid discharge operation). Further, the liquid discharge units 9A and 9B may include a fan to circulate airflow in the front cover 7 or the rear cover 8 to collect the generated mist of the ink (i.e., ink mist) in the front cover 7 or the rear cover 8.

The liquid discharge apparatus 1 according to the present embodiment includes the two liquid discharge units 9A and 9B arranged side by side in the directions X. The liquid discharge unit 9A discharges color ink and white ink. The liquid discharge unit 9B discharges a pretreatment liquid.

The liquid discharged by each of the liquid discharge units 9A and 9B is not limited to the above example, and any liquid of the color ink, the white ink, and the pretreatment liquid may be discharged by each of the liquid discharge units 9A and 9B. In particular, when the recording medium is a fabric, the pretreatment liquid is preferably applied to the recording medium before the image formation using the ink. In other words, one of the liquid discharge units 9A and 9B preferably discharges the pretreatment liquid.

Since the liquid discharge units 9A and 9B have similar configurations, the liquid discharge unit 9A is described below. The liquid discharge unit 9A includes a carriage 10A, a guide rod 11, an electrical component unit 12 including, for example, a board and an electrical component cover, and the maintenance unit 30. The liquid discharge units 9A and 9B and the carriages 10A and 10B may be referred to simply as a liquid discharge unit 9 and a carriage 10, respectively, unless distinguished.

The guide rod 11 extends in the main scanning direction. The carriage 10 is movable in the main scanning direction along the guide rod 11. In the present embodiment, the carriage 10 includes multiple liquid discharge heads. Alternatively, the carriage 10 may include one liquid discharge head. The maintenance unit 30 is disposed at a position facing the guide rod 11 outside a liquid discharge region on one side in the transverse direction (directions Y).

The maintenance unit 30 includes, for example, a wiping member that cleans a nozzle face of the liquid discharge head and a suction mechanism that sucks the nozzle face. The wiping member may be a wiper made of, for example, rubber, or a web made of, for example, nonwoven fabric.

The process of forming an image on the recording medium is described below.

The recording medium is placed on the stage 3 and conveyed along the guide rail 4. The recording medium is conveyed to a rear side of the liquid discharge apparatus 1, and the pretreatment liquid is applied to the recording medium by the liquid discharge unit 9B. Specifically, while the carriage 10B moves in the main scanning direction along the guide rod 11, the liquid discharge unit 9B discharges the pretreatment liquid from the nozzles of the liquid discharge head to apply the pretreatment liquid to the entire width of the recording medium in the main scanning direction. The application of the pretreatment liquid is repeated at multiple positions in the sub-scanning direction. As a result, the pretreatment liquid is applied to the entire recording medium.

After that, the stage 3 moves forward, and the liquid discharge unit 9A discharges the color ink of multiple colors onto the recording medium using a method similar to that of the liquid discharge unit 9B. When white color is printed on the recording medium, for example, the liquid discharge unit 9A discharges the white ink onto the recording medium, the stage 3 moves to the rear side of the liquid discharge unit 9A again, and the liquid discharge unit 9A discharges the color ink onto the recording medium. Thus, an image is formed on the recording medium.

The ink is supplied from the ink cartridge 6 to the liquid discharge head mounted on the carriage 10 by an ink supply pump and an ink supply tube. In FIGS. 3 and 4, illustrations of the ink supply pump and the ink supply tube are omitted.

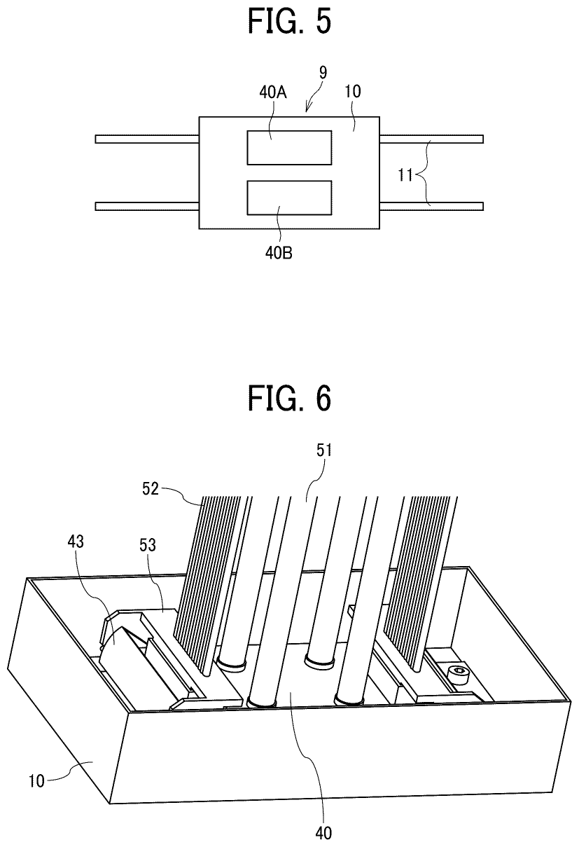

FIG. 5 is a schematic plan view of the liquid discharge unit 9. In FIG. 5, two liquid discharge heads are mounted on one carriage 10. As illustrated in FIG. 5, the carriage 10 may include multiple liquid discharge heads 40A and 40B. The liquid discharge head 40A is disposed on the back side of the liquid discharge apparatus 1, and the liquid discharge head 40B is disposed on the front side of the liquid discharge apparatus 1. The multiple liquid discharge heads 40A and 40B may collectively be referred to as liquid discharge heads 40, each of which may be referred to as a liquid discharge head 40 unless distinguished. In this case, for example, the pretreatment liquid is discharged by the liquid discharge head 40A, and the white ink or the color ink is discharged by the liquid discharge head 40B.

A detailed description is given below according to the present embodiment.

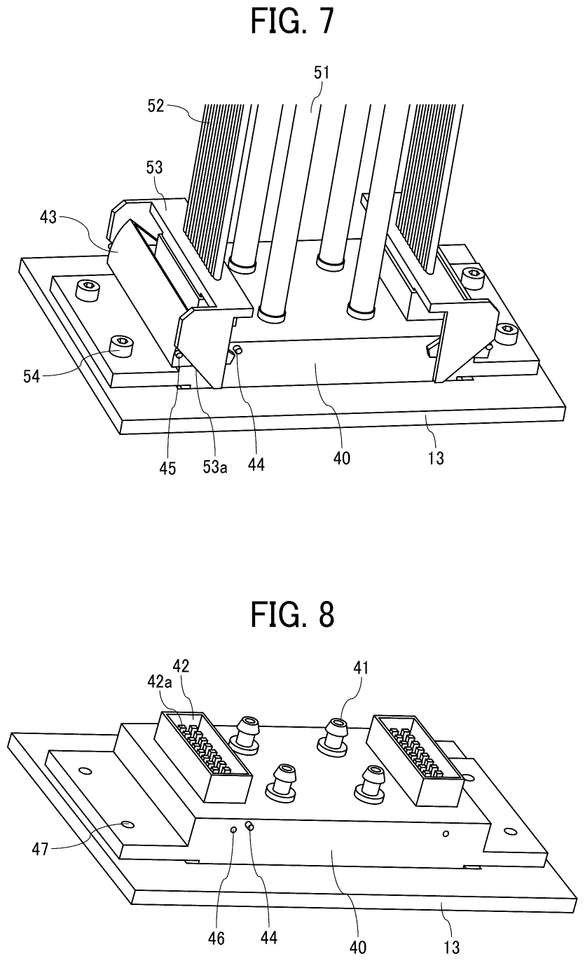

FIG. 6 is a schematic perspective view of a part of the carriage 10 on which a liquid discharge head is mounted. In FIG. 6, illustrations of a drive mechanism and the guide rod 11 are omitted. FIG. 7 is a perspective view of the liquid discharge head of FIG. 6 from which the illustration of a side wall of the carriage 10 is omitted.

In FIGS. 6 and 7, some reference signs are omitted for simplicity. For example, although four ink supply tubes 51 are illustrated, only one of them is denoted by a reference sign. Similarly, although two signal wires 52, two plugs 53, and two covers 43 are illustrated, only one of the respective components is denoted by reference signs. The same applies to the other components.

A liquid discharge head 40 is mounted on the carriage 10. The liquid discharge head 40 is detachably mounted on, for example, a head fixing plate 13 of the carriage 10. The liquid discharge head 40 is fastened by, for example, a screw 54.

Multiple liquid discharge heads 40 may be mounted on the carriage 10. As illustrated in FIG. 6, one liquid discharge head 40 is mounted on the carriage 10, but embodiments of the present disclosure are not limited thereto. Multiple liquid discharge heads may be mounted on the carriage 10 as illustrated in FIG. 5, instead of one. In the following description according to the present embodiment, one liquid discharge head 40 is mounted on the carriage 10, and the description of the present embodiment also applies to the multiple liquid discharge heads mounted on the carriage 10. Alternatively, one or multiple liquid discharge head units each including multiple liquid discharge heads may be mounted on the carriage 10.

FIGS. 6 and 7 illustrate the liquid discharge head 40 on the carriage 10. The signal wire 52 and the ink supply tube 51 are connected to the liquid discharge head 40. The ink supply tube 51 is an example of a supply path to supply liquid (e.g., ink) to the liquid discharge head 40. The signal wire 52 is an example of a signal wire to transmit an electrical signal to the liquid discharge head 40. The signal wire 52 may be referred to as, for example, wiring, electrical wiring, or cable. Examples of the electrical signal include a drive signal for driving the liquid discharge head 40 and a control signal for controlling the liquid discharge head 40. The signal wire 52 may supply electric power to the liquid discharge head 40.

In FIG. 6, multiple signal wires 52 and multiple ink supply tubes 51 are connected to the liquid discharge head 40. For example, the liquid discharge head 40 discharges multiple color inks supplied from the multiple ink supply tubes 51. The ink supply tube 51 supplies, for example, ink of various colors. In addition, for example, the pretreatment liquid may be supplied to the liquid discharge head 40 through the ink supply tube 51. As described later, since the present embodiment may be applied to a circulation type liquid discharge head, one kind of liquid may correspond to, for example, two ink supply tubes 51.

The signal wire 52 is supported by the plug 53. The plug 53 is an example of a signal wire support. The plug 53 is coupled to a signal connector of the liquid discharge head 40 or the liquid discharge head 40 to connect the signal wire 52 to the liquid discharge head 40.

FIG. 8 is a perspective schematic view of the liquid discharge head 40 of FIG. 7 from which the ink supply tube 51, the signal wire 52, the screw 54, and the cover 43 are removed. The liquid discharge head 40 has screw holes 47 for the screw 54.

The cover 43 is described later.

As illustrated in FIG. 8, the liquid discharge head 40 includes an ink inlet 41 and a socket 42. The ink inlet 41 is an example of a supply connector and is connectable to the ink supply tube 51. The ink supply tube 51 is directly fitted onto the ink inlet 41, for example, in FIGS. 6 and 7, but embodiments of the present disclosure are not limited thereto. For example, the ink supply tube 51 and the ink inlet 41 may be connected via a tube joint.

The ink inlet 41 (supply connector) is described in the present embodiment, but embodiments of the present disclosure are not limited to a non-circulation type liquid discharge head. The present embodiment may be applied to the circulation type liquid discharge head. In this case, an ink outlet similar to the ink inlet 41 is provided. The ink outlet may be referred to as, for example, an outlet path connector, a collection path connector, or a drain path connector. In this case, an ink outlet tube similar to the ink supply tube 51 is provided. The ink outlet tube may be referred to as, for example, an outlet path, a collection path, or a drain path.

The socket 42 is an example of the signal connector and is connectable to the signal wire 52. In FIG. 8, for example, two sockets 42 are provided, but the number of sockets 42 is not limited thereto, and may be one or more than two. The socket 42 may be referred to as, for example, a connector.

In the present embodiment, the plug 53 is fitted into the socket 42 to connect the signal wire 52 to the liquid discharge head 40. In the present embodiment, a connection terminal 42a in the socket 42 is connected to the signal wire 52. The connection terminal 42a has multiple projections as illustrated in FIG. 8 and is an example of a portion to be connected to the signal wire 52 in the socket 42 (signal connector). Even in such a configuration having the connection terminal 42a, the socket 42 may be referred to as being connected to the signal wire 52. The signal wire 52 may be referred to as being connected to the socket 42, or may be referred to as being connected to the liquid discharge head 40 or the liquid discharge head unit.

As illustrated in, for example, FIGS. 7 and 8, the socket 42 and the plug 53 have a simple plug-and-socket configuration, but embodiments of the present disclosure are not limited thereto. Other electrical connectors may be used as a socket and a plug.

Coupling the plug 53 to the socket 42 may be referred to as, for example, mounting, fitting, attaching, or installing. Connecting the ink supply tube 51 to the ink inlet 41 may be referred to as, for example, mounting, fitting, attaching, installing, or coupling.

As illustrated in, for example, FIG. 8, the ink inlet 41 and the socket 42 are disposed on an upper face of the liquid discharge head 40 in the present embodiment. When the ink inlet 41 and the socket 42 are disposed on the upper face of the liquid discharge head 40, for example, as illustrated in FIG. 6, the ink supply tube 51 and the signal wire 52 can be connected to the liquid discharge head 40 in the carriage 10 in the same direction, which leads to the downsizing of the apparatus. Such a configuration facilitates the arrangement of components in the apparatus.

In FIG. 8, four ink inlets 41 are illustrated, but embodiments of the present disclosure are not limited thereto. The number of ink inlets 41 may be other than four, and may be, for example, one. In FIG. 8, two sockets 42 are illustrated, but embodiments of the present disclosure are not limited thereto. The number of sockets 42 may be other than two, and may be, for example, one.

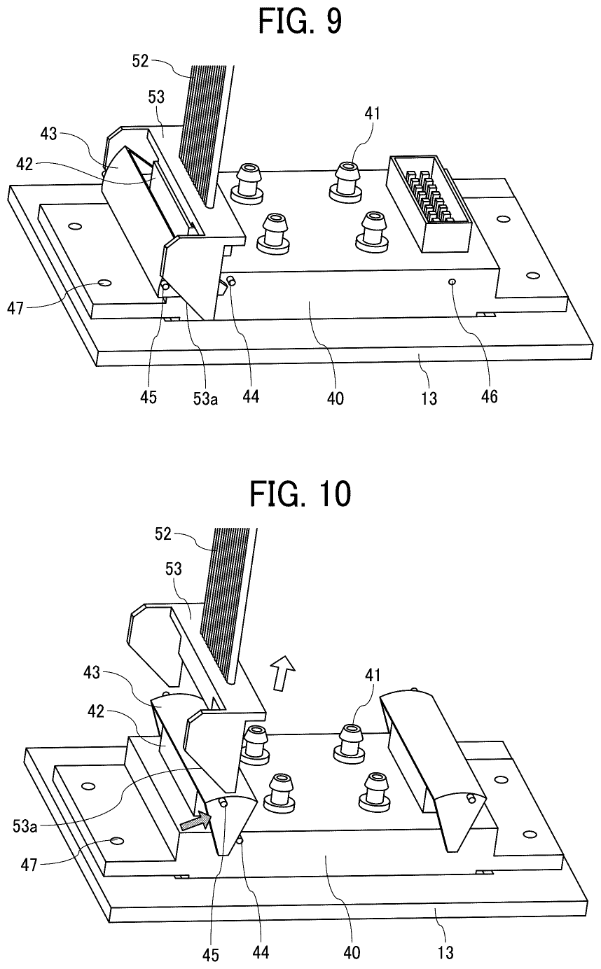

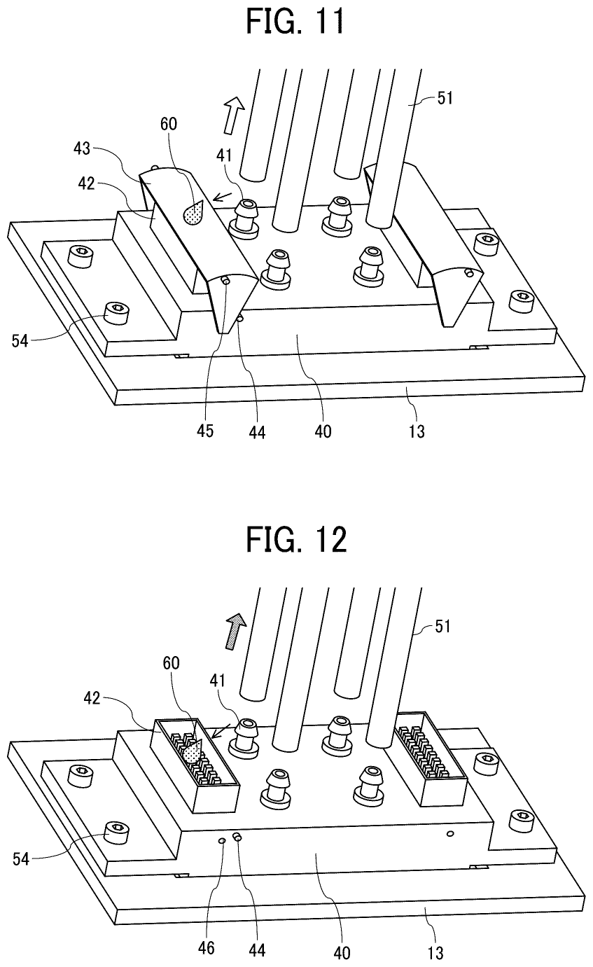

FIGS. 9 and 10 are schematic views of the liquid discharge head 40 according to the present embodiment, illustrating the cover 43. FIG. 9 illustrates the liquid discharge head 40 to which the signal wire 52 is connected, and FIG. 10 illustrates the liquid discharge head 40 from which the signal wire 52 has been removed.

As illustrated in FIGS. 6, 7, 9, and 10, the liquid discharge head 40 according to the present embodiment or the liquid discharge head unit includes the cover 43. The cover 43 is an example of a cover according to the present embodiment. The cover 43 may be referred to as, for example, a socket cover, or cover member.

As illustrated in FIGS. 6, 7, and 9, the cover 43 is at a position where the cover 43 does not cover the socket 42 when the socket 42 (signal connector) and the signal wire 52 are connected (i.e., an exposing position). As illustrated in FIG. 10, the cover 43 can cover the socket 42 when the socket 42 is not connected to the signal wire 52.

When the signal wire 52 is removed from the socket 42 from the state illustrated in FIG. 9, the cover 43 moves to a position where the cover 43 covers the socket 42 (i.e., a covering position). This movement is illustrated in FIG. 10. The signal wire 52 is being removed from the socket 42 in the direction indicated by the blank arrow in FIG. 10, and the cover 43 moves to the position where the cover 43 covers the socket 42 in the direction indicated by the solid arrow in FIG. 10.

In other words, the liquid discharge head 40 according to the present embodiment or the liquid discharge head unit has a structure in which the cover 43 automatically covers the socket 42 when the signal wire 52 is removed. When the signal wire 52 is removed, the cover 43 automatically moves to the position where the cover 43 covers the socket 42 in conjunction with the movement of the signal wire 52.

In the present embodiment, the cover 43 automatically moves to the position where the cover 43 covers the socket 42 in conjunction with the movement of removing the signal wire 52, without manually moving the cover 43. When the signal wire 52 has been removed, the cover 43 automatically covers the socket 42. Thus, the cover 43 reliably covers the socket 42. Accordingly, a period during which the socket 42 may be stained with liquid (e.g., ink) can be reduced, and the possibility that the socket 42 is stained with liquid can be reduced.

The cover 43 moves to the position where the cover 43 covers the socket 42 while the signal wire 52 is being removed. As a result, the socket 42 can be prevented from being stained with liquid even during the removal of the signal wire 52. For example, even when the signal wire 52 and the ink supply tube 51 are simultaneously or substantially simultaneously removed, the socket 42 can be prevented from being stained with liquid. Thus, in the present embodiment, the cover 43 can prevent liquid from adhering to the socket 42 and staining the socket 42 not only after the signal wire 52 has been removed but also during the removal of the signal wire 52.

In the above description, the signal wire 52 is removed from the socket 42. Alternatively, the plug 53 may be referred to as being removed from the socket 42. Removing the signal wire 52 may be referred to as, for example, unplugging, pulling out, disconnecting, releasing the connection of, or disengaging the signal wire 52.

FIG. 11 is a perspective view of the liquid discharge head 40 with the cover 43 preventing liquid from staining the socket 42. FIG. 11 illustrates the liquid discharge head 40 after the signal wire 52 is removed and the cover 43 moves to the position where the cover 43 covers the socket 42. The signal wire 52 and the socket 42 are not connected in FIG. 11, and thus, the cover 43 covers the socket 42. When the ink supply tube 51 is removed in this state, even if a liquid 60 splashes from the ink supply tube 51, the cover 43 can prevent the liquid 60 from adhering to the socket 42. As a result, the socket 42 can be prevented from being stained with the liquid 60. Thus, the liquid 60 can be prevented from adhering to the signal connector to be connected to the signal wire 52, and malfunction of the liquid discharge head 40 can be prevented.

Although not limited to a particular situation, the ink supply tube 51 is removed, for example, when the liquid discharge head 40 is removed from the carriage 10 and replaced. The ink supply tube 51 may be removed, for example, when the liquid discharge head unit instead of the liquid discharge head 40 is replaced.

Further, according to the present embodiment, the increase in the size of the liquid discharge head 40 as a replacement unit can be prevented.

FIG. 12 is a schematic view of the liquid discharge head 40 without the cover 43. As illustrated in FIG. 12, when the ink supply tube 51 is removed, if the liquid 60 splashes from the ink supply tube 51, the liquid 60 may enter the socket 42. This may cause, for example, a short circuit or a contact (conduction) failure, and the operation failure of the liquid discharge head 40 may occur.

In the present embodiment, the position where the cover 43 covers the socket 42 may be referred to as a first position, and the position where the cover 43 does not cover the socket 42 may be referred to as a second position. The movement of the cover 43 between the first position and the second position may be referred to as, for example, shift or transition. The movement of the cover 43 from the first position to the second position may be referred to as the opening of the cover 43. The movement of the cover 43 from the second position to the first position may be referred to as the closing of the cover 43.

A method for automatically moving the cover 43 to the position (first position) where the cover 43 covers the socket 42 when the signal wire 52 is removed can be appropriately selected. For example, the cover 43 is preferably biased toward the position (first position) where the cover 43 covers the socket 42. In this case, the configuration in which the cover 43 automatically moves to the position where the cover 43 covers the socket 42 when the signal wire 52 is removed can be constructed with a simple structure.

A method for biasing the cover 43 is not limited to a particular method, and for example, a torsion coil spring is used to bias the cover 43 so as to move the cover 43 to the first position. In FIG. 10, the illustration of a biasing means such as the torsion coil spring is omitted.

The shape of the cover 43 can be appropriately selected. As illustrated in FIG. 10, the cover 43 preferably does not expose the upper face of the socket 42 in the vertical direction when the cover 43 is at the position where the cover 43 covers the socket 42. In other words, the cover 43 preferably has a shape that covers the entire upper face of the socket 42 when the cover 43 covers the socket 42. In this case, the cover 43 reliably prevents the portion of the socket 42 to be connected to the signal wire 52 from being stained with liquid. For example, when the ink supply tube 51 is removed, the cover 43 reliably prevent dripping liquid such as dripping ink from entering the socket 42.

Not exposing the upper face of the socket 42 in the vertical direction means that the upper face of the socket 42 is not seen as viewed in the vertical direction when the cover 43 is at the position where the cover 43 covers the socket 42.

The case when the signal wire 52 is connected is described below according to the present embodiment.

When the signal wire 52 is connected to the socket 42 with the cover 43 at the position where the cover 43 covers the socket 42, the cover 43 preferably moves to the position where the cover 43 does not cover the socket 42. In other words, preferably, the cover 43 automatically moves to the position where the cover 43 does not cover the socket 42 along with the operation of connecting the signal wire 52 to the socket 42. In this case, the signal wire 52 can be connected to the socket 42 without manually moving the cover 43.

Thus, the cover 43 is automatically shifted from the first position to the second position along with the operation of connecting the signal wire 52, from the state in FIG. 10 to the state in FIG. 9. In this case, the signal wire 52 is being connected to the socket 42 in the direction opposite to the direction indicated by the blank arrow in FIG. 10, and the cover 43 moves to the position where the cover 43 does not cover the socket 42 in the direction opposite to the direction indicated by the solid arrow in FIG. 10. From the state in FIG. 10 to the state in FIG. 9, the cover 43 is shifted to the second position along with the operation of connecting the signal wire 52 without being manually moved. The automatic shift of the cover 43 means that the cover 43 is moved without being manually moved.

The operation of connecting the signal wire 52 may be referred to as an operation of connecting the signal wire 52 to the socket 42 or the liquid discharge head 40, or may be referred to as an operation of coupling the plug 53 to the socket 42 or the liquid discharge head 40. Similarly, the operation of removing the signal wire 52 may be referred to as an operation of removing the signal wire 52 from the socket 42 or the liquid discharge head 40, or may be referred to as the operation of removing the plug 53 from the socket 42 or the liquid discharge head 40. The operation of connecting the signal wire 52 may be referred to as an operation of mounting or inserting the plug 53 onto or into the socket 42.

The movement of the cover 43 to the first position and the second position can be appropriately selected. The cover 43 preferably swings between the first position where the cover 43 covers the socket 42 and the second position where the cover 43 does not cover the socket 42. When the cover 43 swings, the range of movement of the cover 43 can be narrowed. Accordingly, the cover 43 does not excessively occupy a movement region in the carriage 10. As a result, the increase in the size of the liquid discharge head 40 can be prevented.

To swing the cover 43, for example, as illustrated in FIG. 8, the liquid discharge head 40 has an attachment hole 46 to which the cover 43 is attached. In this case, the cover 43 has a projection or a shaft corresponding to the attachment hole 46, and the projection or the shaft of the cover 43 is fitted into the attachment hole 46. Due to such a configuration, the cover 43 is swingable.

The liquid discharge head 40 preferably has a detent pin 44 as illustrated in FIG. 8 when the cover 43 is swingable. The detent pin 44 can restrict the swingable range of the cover 43. In addition, the cover 43 can be prevented from contacting other components.

A method for automatically moving the cover 43 between the first position and the second position can be appropriately selected. For example, as illustrated in FIG. 10, the cover 43 includes a contact pin 45 as an example of a projection. In this case, the plug 53 has a contact face 53a that contacts the contact pin 45. Due to such a configuration, when the plug 53 is about to be coupled to the socket 42, the contact face 53a comes into contact with the contact pin 45, and the cover 43 swings as the plug 53 is inserted into the socket 42. By the swing of the cover 43, the socket 42 is exposed, the connection portion of the plug 53 is inserted into the socket 42, and the signal wire 52 is connected to the connection terminal 42a in the socket 42. Thus, the cover 43 swings from the first position to the second position.

The same applies to the case when the cover 43 moves from the second position to the first position. When the plug 53 is removed from the socket 42, the cover 43 swings while the contact face 53a contacts the contact pin 45. Thus, the cover 43 swings from the second position to the first position.

The contact pin 45 and the plug 53 according to the present embodiment are described below again.

In the present embodiment, the signal wire 52 is supported by the plug 53 (signal wire support). Preferably, the cover 43 has the contact pin 45 (projection) that contacts the plug 53. The cover 43 swings toward the first position or the second position while the contact pin 45 and the plug 53 are in contact with each other when the signal wire 52 is removed from the socket 42 or when the signal wire 52 is about to be connected to the socket 42, respectively. In this case, the cover 43 can be shifted with a simple structure.

In the present embodiment, one cover 43 is preferably provided for one socket 42. The number of covers 43 and the number of sockets 42 are not limited to any particular number, and may be one or plural. Although the cover 43 is illustrated for both of the two sockets 42 in FIG. 10, the illustration of the cover 43 corresponding to the right socket 42 is omitted in FIG. 9.

A liquid discharge head 40 according to another embodiment of the present disclosure is described below. Descriptions of items similar to the items of the above-described embodiment are omitted.

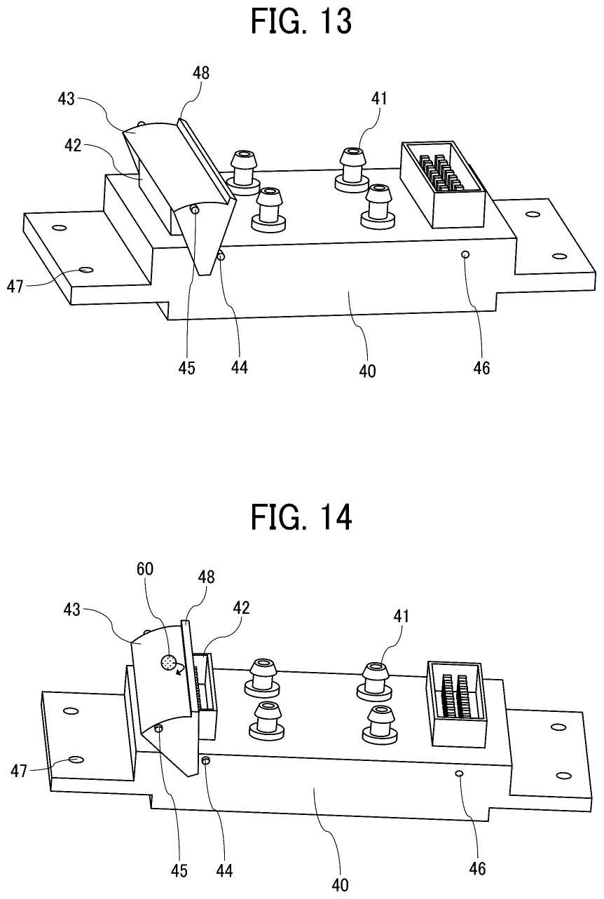

FIGS. 13 and 14 are schematic views of a liquid discharge head 40 according to an embodiment of the present disclosure. FIGS. 13 and 14 are the schematic views of the same liquid discharge head 40 as viewed in the different directions.

In the present embodiment, the cover 43 includes a rib 48 on a part of the upper face. The rib 48 is an example of a dam. The rib 48 blocks liquid on the cover 43 to prevent the liquid from dripping into the socket 42. The rib 48 may be effective in blocking the liquid when the cover 43 is moving and when the cover 43 is stationary.

For example, the cover 43 including the rib 48 can prevent liquid adhering to the upper surface of the cover 43 from falling from the cover 43 and entering the socket 42 when the cover 43 is moving. In addition, the cover 43 including the rib 48 can prevent the liquid from dripping into the socket 42 along the cover 43 when the cover 43 is stationarily disposed at the position where the cover 43 covers the socket 42. As schematically illustrated in FIG. 14, according to the present embodiment, the liquid 60 adhering to the upper surface of the cover 43 can be prevented from falling to the socket 42 by the rib 48.

The shape of the rib 48 can be appropriately selected, and the rib preferably projects from the upper surface of the cover 43 at an edge of the cover 43 as illustrated in FIGS. 13 and 14. In this case, the rib 48 can be easily formed. The position where the rib 48 is disposed can be appropriately selected. As illustrated in FIGS. 13 and 14, the rib 48 is preferably disposed at the leading edge of the upper surface of the cover 43 in the direction in which the cover 43 moves from the position where the cover 43 does not cover the socket 42 to the position where the cover 43 covers the socket 42. In this case, the rib 48 can reliably prevent the liquid 60 on the cover 43 from falling to the socket 42 when the cover 43 moves.

Preferred examples of the present embodiment described above are described again.

Preferably, the rib 48 has a projection shape disposed on the edge of the upper surface of the cover 43. The edge is disposed on the outermost end side of the upper surface of the cover 43 in the direction in which the cover 43 moves from the position where the cover 43 does not cover the socket 42 to the position where the cover 43 covers the socket 42.

The edge may be referred to as, for example, a side. The edge used herein may be a straight line or may not be a straight line. In the case of the dam not having the projection shape, for example, a dam may have a recessed shape for storing liquid, but the dam preferably has the projection shape as described above.

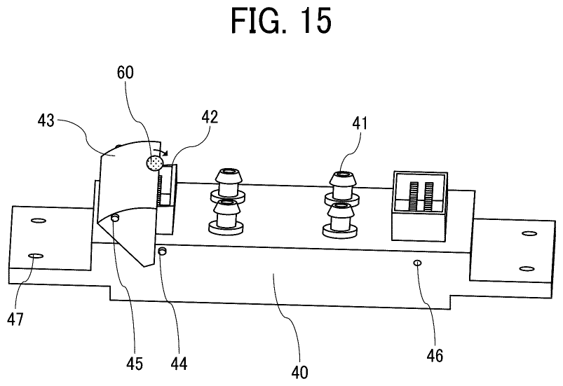

FIG. 15 is a schematic view of the liquid discharge head 40 including the cover 43 without the rib 48. In the embodiment illustrated in FIG. 15, the liquid 60 on the cover 43 may drip to the socket 42 depending on, for example, the type of the liquid 60 and the material or shape of the cover 43. For this reason, the embodiment illustrated in FIGS. 13 and 14 is more preferable than the embodiment illustrated in FIG. 15.

However, embodiments of the present disclosure do not exclude the embodiment illustrated in FIG. 15. In addition to the case where the liquid 60 is less likely to drip, the cover 43 without the rib 48 can prevent the stain of the socket 42 with the liquid 60, for example, in the case where the cover 43 moves in a manner other than swinging, or the case where the shape of the cover 43 prevents the liquid 60 on the cover 43 from dripping to the socket 42.

Aspects of the present disclosure are, for example, as follows.

### Aspect 1

A liquid discharge head mounted on a carriage includes a supply connector, a signal connector, and a cover. The supply connector is connectable to a supply path to supply a liquid to the liquid discharge head. The signal connector is connectable to a signal wire to transmit an electrical signal to the liquid discharge head. The cover covers the signal connector. The cover is disposed at a position where the cover does not cover the signal connector when the signal connector and the signal wire are connected. The cover moves to a position where the cover covers the signal connector when the signal wire is removed from the signal connector.

In other words, a liquid discharge head includes a supply connector, a signal connector, and a cover. The supply connector is connectable to a supply path to be supplied with a liquid from the supply path. The signal connector is connectable to a signal wire through which an electrical signal is transmitted. The cover is movable between an exposing position where the signal connector is exposed to be connectable with the signal wire and a covering position where the cover covers the signal connector from which the signal wire is disconnected.

### Aspect 2

In the liquid discharge head according to Aspect 1, when the cover is disposed at the position where the cover covers the signal connector, the cover does not expose a vertical top of the signal connector.

In other words, the cover at the covering position covers an entire of a connection face of the signal connector above the connection face.

### Aspect 3

In the liquid discharge head according to Aspect 1 or 2, the cover moves to the position where the cover does not cover the signal connector when the signal wire is connected to the signal connector in a state where the cover is located at the position where the cover covers the signal connector.

In other words, the cover moves from the covering position to the exposing position in response to a connection of the signal wire to the signal connector.

### Aspect 4

In the liquid discharge head according to any one of Aspects 1 to 3, the cover is biased so as to be located at the position where the cover covers the signal connector.

In other words, the cover is biased toward the covering position.

### Aspect 5

In the liquid discharge head according to any one of Aspects 1 to 4, the cover rotates between a first position where the cover covers the signal connector and a second position where the cover does not cover the signal connector.

In other words, the cover is swingable between the exposing position and the covering position in a swing direction.

### Aspect 6

In the liquid discharge head according to Aspect 5, the signal wire is supported by a signal wire support, and the cover has a projection that comes into contact with the signal wire support. When the signal wire is connected to the signal connector or when the signal wire is removed from the signal connector, the cover rotates toward the first position or the second position while the projection and the signal wire support are in contact with each other.

In other words, a liquid discharge apparatus includes the liquid discharge head according to Aspect 5. The signal wire includes a signal wire support at a leading end of the signal wire to support the signal wire. The cover includes a projection contactable with the signal wire support of the signal wire. The signal wire support of the signal wire being connected to the signal connector contacts the projection of the cover to cause the cover to swing from the covering position to the exposing position. The signal wire support of the signal wire being disconnected from the signal connector causes the projection of the cover contacting the signal wire support to swing from the exposing position to the covering position.

### Aspect 7

In the liquid discharge head according to any one of Aspects 1 to 6, the cover has a dam on a part of an upper surface of the cover, and the dam dams to prevent a liquid on the cover from dripping to the signal connector.

In other words, the cover includes a rib on a part of an upper face of the cover in the swing direction.

### Aspect 8

In the liquid discharge head according to Aspect 7, the dam has a projection shape disposed on an edge of an upper surface of the cover. The edge is disposed on an outermost end side of the upper surface of the cover in a direction in which the cover moves from the position where the cover does not cover the signal connector to the position where the cover covers the signal connector.

In other words, the rib projects above from the upper face of the cover at a leading end side of the cover in the swing direction from the exposing position to the covering position.

### Aspect 9

A liquid discharge apparatus includes the carriage on which the liquid discharge head according to any one of Aspects 1 to 8 is mounted, the supply path, and the signal wire.

In other words, a liquid discharge apparatus includes a liquid discharge head according to any one of Aspects 1 to 8, a carriage on which the liquid discharge head is mountable, the supply path to supply the liquid to the liquid discharge head, and the signal wire to transmit the electrical signal to the liquid discharge head.

As described above, according to one aspect of the present disclosure, a liquid discharge head can be provided that prevents liquid from adhering to and staining a connection portion of the signal connector not only after the signal wire has been removed from the signal connector but also during the removal of the signal wire.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a supply connector connectable to a supply path to be supplied with a liquid from the supply path;
a signal connector connectable to a signal wire through which an electrical signal is transmitted; and
a cover movable between:
an exposing position where the signal connector is exposed to be connectable with the signal wire; and
a covering position where the cover covers the signal connector from which the signal wire is disconnected.

2. The liquid discharge head according to claim 1,
wherein the cover at the covering position covers an entire of a connection face of the signal connector above the connection face.

3. The liquid discharge head according to claim 1,
wherein the cover moves from the covering position to the exposing position in response to a connection of the signal wire to the signal connector.

4. The liquid discharge head according to claim 1,
wherein the cover is biased toward the covering position.

5. The liquid discharge head according to claim 1,
wherein the cover is swingable between the exposing position and the covering position in a swing direction.

6. A liquid discharge apparatus comprising:
the liquid discharge head according to claim 5,
wherein the signal wire includes a signal wire support at a leading end of the signal wire to support the signal wire,
the cover includes a projection contactable with the signal wire support of the signal wire,
the signal wire support of the signal wire being connected to the signal connector contacts the projection of the cover to cause the cover to swing from the covering position to the exposing position; and
the signal wire support of the signal wire being disconnected from the signal connector causes the projection of the cover contacting the signal wire support to swing from the exposing position to the covering position.

7. The liquid discharge head according to claim 5,
wherein the cover includes a rib on a part of an upper face of the cover in the swing direction.

8. The liquid discharge head according to claim 7,
wherein the rib projects above from the upper face of the cover at a leading end side of the cover in the swing direction from the exposing position to the covering position.

9. A liquid discharge apparatus comprising:
the liquid discharge head according to claim 1;
a carriage on which the liquid discharge head is mountable;
the supply path to supply the liquid to the liquid discharge head; and
the signal wire to transmit the electrical signal to the liquid discharge head.
